(19) United States
(12) Patent Application Publication
(10) Pub. No.: US 2024/0371557 A1
(43) Pub. Date: Nov. 7, 2024

(54) SOLENOID AND SWITCH

(71) Applicant: Mitsubishi Electric Corporation, Chiyoda-ku, Tokyo (JP)

(72) Inventors: Akira NISHI, Chiyoda-ku, Tokyo (JP); Tomohiro NAKATA, Chiyoda-ku, Tokyo (JP); Takayuki KAI, Chiyoda-ku, Tokyo (JP)

(73) Assignee: Mitsubishi Electric Corporation, Chiyoda-ku, Tokyo (JP)

(21) Appl. No.: 18/688,989

(22) PCT Filed: Nov. 9, 2021
(86) PCT No.: PCT/JP2021/041063

§ 371 Date: Mar. 4, 2024

(51) Int. Cl. H01F 7/16; H01H 50/36; H01H 50/54

(52) U.S. Cl. CPC H01F 7/1607; H01H 50/36; H01H 50/54

(57) ABSTRACT

A solenoid, in which rectilinear motion of a movable core can be efficiently performed by providing a step in an end portion on a solenoid coil side of a protrusion portion, is obtained. The solenoid is provided with a solenoid coil, a movable core, and a fixed core. One end of the movable core is rectilinearly moved in a hollow portion of the solenoid coil, and the movable core has, on the other end side, a protrusion portion which is provided in a right-and-left symmetrical manner in a direction perpendicular to a rectilinear motion direction and whose end portion on the solenoid coil side is tiered. The fixed core surrounds the solenoid coil and is provided with a concave portion in which the protrusion portion is to be fitted.

Buchanan

### TECHNICAL FIELD

The present disclosure relates to a solenoid and a switch using the solenoid.

### BACKGROUND ART

A solenoid is one of actuators which is composed of a fixed core, a movable core, and a solenoid coil through which a current flows and thus a magnetic flux is generated. A protrusion portion referred to as a stopper is provided on an upper portion of the movable core, the protrusion portion being perpendicular to a movement direction.

When the current flows through the solenoid coil, the magnetic flux is generated and the magnetic flux flows in a space gap between the fixed core and the movable core and thus electromagnetic force is exerted. This electromagnetic force enables the movable core to move rectilinearly to the fixed core side by functioning as force (hereinafter, referred to as suction force) and the movable core stops by bringing the stopper into contact with the fixed core.

Formerly, there has been disclosed a solenoid that reduces a space gap by providing a convex portion at a lower portion of a movable core. (For example, refer to Patent Document 1.)

### RELATED ART DOCUMENT

### Patent Document

Patent Document 1: JP-A-2005-116554

### SUMMARY OF THE INVENTION

### Problems to be Solved by the Invention

In the above solenoid, the convex portion provided at the lower portion of the movable core decreases magnetic resistance and thus suction force is improved. But, as the movable core is rectilinearly moved to a direction of the fixed core, the magnetic flux flows in a direction perpendicular to the rectilinear motion direction and the proportion of the magnetic flux that flows in the rectilinear motion direction is reduced.

The present disclosure is implemented to solve the foregoing problem, and an object of the present disclosure is to obtain a solenoid which decreases a magnetic flux, which is generated as a movable core is rectilinearly moved and flows in a direction perpendicular to a rectilinear motion direction, and improves suction force by increasing the magnetic flux of the rectilinear motion direction.

### Means for Solving the Problems

A solenoid according to the present disclosure includes: a solenoid coil which produces a magnetic flux due to excitation by energization and generates electromagnetic force by which suction force is exerted axially in a hollow portion; a movable core whose one end is rectilinearly moved in the hollow portion by the electromagnetic force, and which has, on the other end side, a protrusion portion which is provided in a right-and-left symmetrical manner in a direction perpendicular to a rectilinear motion direction and whose end portion on the solenoid coil side is tiered; and a fixed core which surrounds the solenoid coil and is provided with a concave portion in which the protrusion portion is to be fitted.

### Advantageous Effect of the Invention

According to the solenoid of the present disclosure, the end portion of the protrusion portion of the movable core is tiered, whereby it has an effect which can perform rectilinear motion of the movable core efficiently.

### BRIEF DESCRIPTION OF THE DRAWINGS

FIG. 1 is a perspective view of a solenoid according to Embodiment 1 of the present disclosure;

FIG. 2 is a view showing the solenoid at an initial position according to Embodiment 1 of the present disclosure;

FIG. 3 is a view showing the solenoid at a midway position according to Embodiment 1 of the present disclosure;

FIG. 4 is a view showing the solenoid at a suction position according to Embodiment 1 of the present disclosure;

FIG. 5 is an enlarged view corresponding to an E portion of FIG. 4 according to Embodiment 1 of the present disclosure;

FIG. 6 is a perspective view of a solenoid according to Embodiment 2 of the present disclosure;

FIG. 7 is a view defining the relationship of lengths according to Embodiment 2 of the present disclosure;

FIG. 8 is a view showing the solenoid at an initial position according to Embodiment 2 of the present disclosure;

FIG. 9 is an enlarged view corresponding to a P portion of FIG. 8 and showing the relationship between a magnetic flux that flows in a space gap and suction force according to Embodiment 2 of the present disclosure;

FIG. 10 is a view showing the solenoid at a midway position according to Embodiment 2 of the present disclosure;

FIG. 11 is a view showing the solenoid at a midway position according to Embodiment 2 of the present disclosure;

FIG. 12 is a view showing the solenoid at a suction position according to Embodiment 2 of the present disclosure;

FIG. 13 is a chart in which suction forces of solenoids according to a comparison embodiment and Embodiment 2 of the present disclosure are compared;

FIG. 14 is a view showing a solenoid at an initial position according to Embodiment 3 of the present disclosure;

FIG. 15 is a view showing the solenoid at a midway position according to Embodiment 3 of the present disclosure;

FIG. 16 is a chart in which suction forces of the solenoids according to Embodiment 2 and Embodiment 3 of the present disclosure are compared;

FIG. 17 is a view showing a solenoid at an initial position according to Embodiment 4 of the present disclosure;

FIG. 18 is a view showing the solenoid in which a yoke according to Embodiment 4 4 of the present disclosure is magnetically saturated;

FIG. 19 is a perspective view of a solenoid according to Embodiment 5 of the present disclosure;

FIG. 20 is a view showing the solenoid at an initial position according to Embodiment 5 of the present disclosure;

FIG. 21 is a view showing the solenoid of a first stage in which a yoke according to Embodiment 5 of the present disclosure is magnetically saturated;

FIG. 22 is a view showing the solenoid of a second stage in which the yoke according to Embodiment 5 of the present disclosure is magnetically saturated; and

FIG. 23 is a view showing an example in which the solenoid according to the present disclosure is applied to a switch.

### MODE FOR CARRYING OUT THE INVENTION

Hereinafter, embodiments will be described in detail based on drawings. Incidentally, embodiments to be described below are exemplification. Furthermore, each of the embodiments can be performed combining suitably.

### Embodiment 1

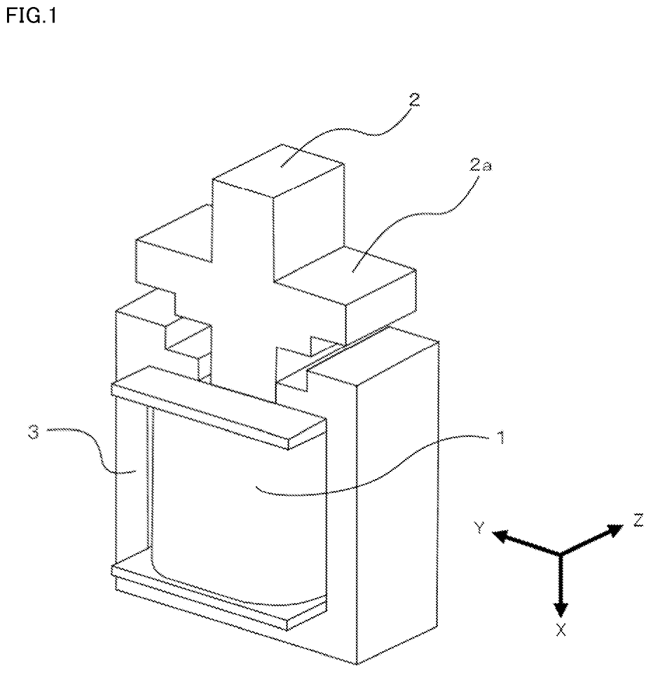

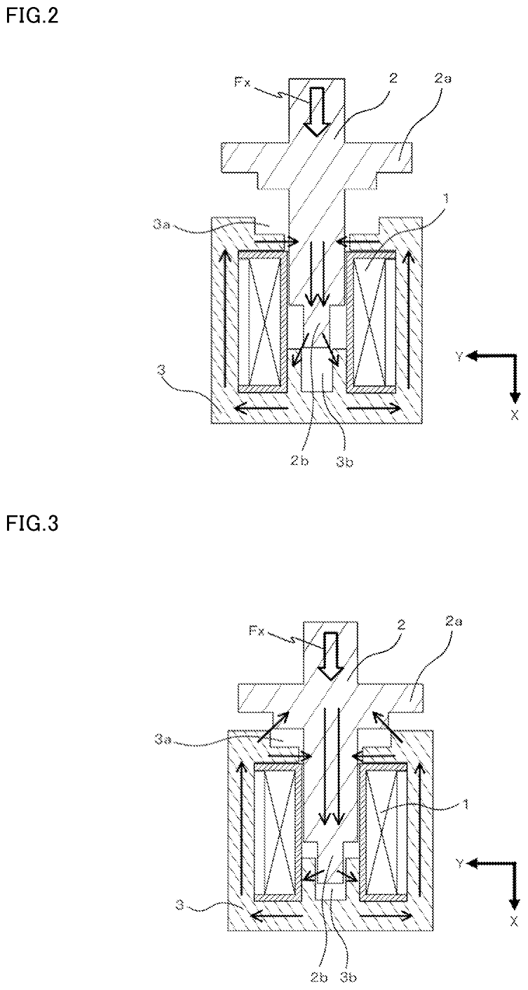

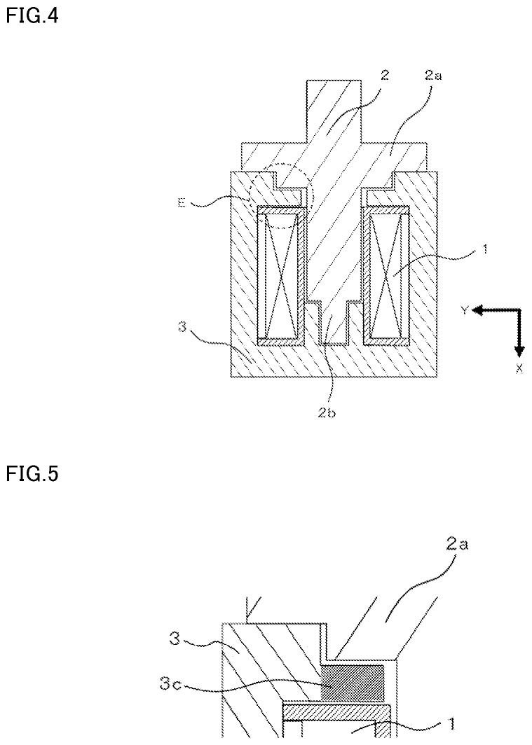

FIG. 1 is a perspective view of a solenoid according to Embodiment 1 of the present disclosure. FIG. 2 is a view showing the solenoid at an initial position according to Embodiment 1 of the present disclosure. FIG. 3 is a view showing the solenoid at a midway position according to Embodiment 1 of the present disclosure. FIG. 4 is a view showing the solenoid at a suction position according to Embodiment 1 of the present disclosure. FIG. 5 is an enlarged view corresponding to an E portion of FIG. 4 according to Embodiment 1 of the present disclosure.

The solenoid shown in FIG. 1 and FIG. 2 includes: a solenoid coil 1 which generates electromagnetic force due to excitation by energization; a movable core 2 whose one end is rectilinearly moved in a hollow portion of the solenoid coil 1, and which has, on the other end side, a protrusion portion 2a which is provided in a right-and-left symmetrical manner in a direction perpendicular to a rectilinear motion direction and whose end portion on the solenoid coil 1 side is tiered; and a fixed core 3 which has a first concave portion 3b in which a convex portion 2b is to be fitted and a second concave portion 3a in which the protrusion portion 2a is to be fitted.

An X-axis shown in FIG. 1 is a rectilinear motion direction of the movable core 2; a Y-axis is a direction in which the protrusion portion 2a perpendicular to the rectilinear motion direction of the movable core 2 is provided; and a Z-axis is a depth direction of the solenoid according to the present embodiment. Although respective axes are illustrated also in subsequent drawings, illustration thereof is the same and thus the description thereof will be omitted.

The solenoid coil 1 is surrounded by the fixed core 3 and is provided so that the movable core 2 is rectilinearly moved in the hollow portion corresponding to an air-core. A magnetic flux is produced due to excitation by energization to generate electromagnetic force. Suction force Fx that rectilinearly moves the movable core 2 axially is exerted in the hollow portion.

The movable core 2 is provided with the convex portion 2b at one end on the solenoid coil 1 side and includes, on the other end side, the protrusion portion 2a that is provided in the right-and-left symmetrical manner in the direction perpendicular to the rectilinear motion direction. The movable core 2 is rectilinearly moved in the hollow portion of the solenoid coil 1 by the suction force Fx and is provided so as to be stopped when the protrusion portion 2a is fitted in the second concave portion 3a of the fixed core 3. Furthermore, the convex portion 2b provided at one end on the solenoid coil 1 side of the movable core 2 is fitted in the first concave portion 3b provided on the fixed core 3 and the movable core is stopped.

The protrusion portion 2a has a stair shape whose end portion on the solenoid coil 1 side is tiered and is provided with one or more steps. Although FIG. 1 shows an example of the protrusion portion 2a having one step, it may be permissible that a plurality of steps is provided. An example provided with a plurality of steps will be described in subsequent embodiments.

The fixed core 3 surrounds the solenoid coil 1 and has the second concave portion 3a on an upper surface in which the protrusion portion 2a is to be fitted at the stop of the rectilinear motion of the movable core 2. The first concave portion 3b, in which the convex portion 2b provided at one end of the movable core 2 is to be fitted at the stop of the rectilinear motion of the movable core 2, is provided at an inside bottom portion of the fixed core 3.

Although the movable core 2 provided with the convex portion 2b at one end is illustrated and described in the present disclosure, the effect described in the present disclosure can be obtained not only in this shape, but also in a movable core 2 having no convex portion 2b. Furthermore, similarly, although the first concave portion 3b provided on the fixed core 3 is illustrated and described, the effect described in the present disclosure can be obtained not only in this shape, but also in a fixed core 3 having no first concave portion 3b.

Next, operation will be described using FIG. 2 through FIG. 4. An arrow in the drawings shows a magnetic flux; a white arrow on a colored (hatched) background shows suction force Fx; and the thickness of the arrow represents magnitude. Furthermore, also in the subsequent embodiments, the magnetic flux and the suction force Fx are illustrated in the same manner and the description thereof will be omitted.

FIG. 2 is the view showing the solenoid at the initial position. When the solenoid coil 1 is energized, a current flows through the solenoid coil 1, the magnetic flux is generated to form a magnetic path. The magnetic flux flows in a space gap between the movable core 2 and the fixed core 3, whereby the suction force Fx is generated and the movable core 2 is rectilinearly moved by in the rectilinear motion direction the suction force Fx, that is, in an X-axis direction.

FIG. 3 is the view showing the solenoid at the midway position. The movable core 2 is rectilinearly moved in the X-axis direction by the suction force Fx and at the timing when a lowermost surface of the protrusion portion 2a begins to fit in the second concave 3a provided on the fixed core 3, more specifically, when the height of the lowermost surface of the protrusion portion 2a conforms to that of the upper surface of the fixed core 3, the magnetic flux (oblique magnetic flux) that flows from the fixed core 3 to the protrusion portion 2a increases.

A component of the X-axis direction of this oblique magnetic flux becomes a part of the suction force Fx that rectilinearly moves the movable core 2 in the X-axis direction. As described above, the magnetic flux obtained from the solenoid coil 1 can be efficiently converted into the suction force Fx.

FIG. 4 is the view showing the solenoid at the suction position. Suction is a state where the rectilinear motion of the movable core 2 is stopped. The movable core 2 is rectilinearly moved by the suction force Fx; and the convex portion 2b and the protrusion portion 2a are respectively fitted in and brought into contact with the first concave portion 3b and the second concave portion 3a, whereby the movable core 2 is stopped.

From the above, the solenoid according to Embodiment 1 includes the movable core 2 which has: the convex portion 2b at one end; and, on the other end side, the stair-shaped protrusion portion 2a which is provided in the right-and-left symmetrical manner in the direction perpendicular to the rectilinear motion direction and whose end portion on the solenoid coil 1 side is tiered, thereby generating the oblique magnetic flux that flows from the fixed core 3 to the protrusion portion 2a. This obtains an effect in which the component in the rectilinear motion direction of the oblique magnetic flux can be converted into the suction force Fx and the movable core 2 can be rectilinearly moved efficiently.

Furthermore, the present embodiment shows the fixed core 3 shown in FIG. 1 through FIG. 4; however, a similar effect is obtained also in a fixed core 3 that is different in shape. A specific shape of the fixed core 3 will be described using FIG. 5. FIG. 5 is the enlarged view corresponding to the E portion of FIG. 4. Description has been made as an example of the fixed core 3 that has a projection portion 3c in which hatching different from others is applied; however, a similar effect is obtained even in a fixed core 3 having no projection portion 3c. In subsequent embodiments, a fixed core 31 having no projection portion 3c will be illustrated and described.

### Embodiment 2

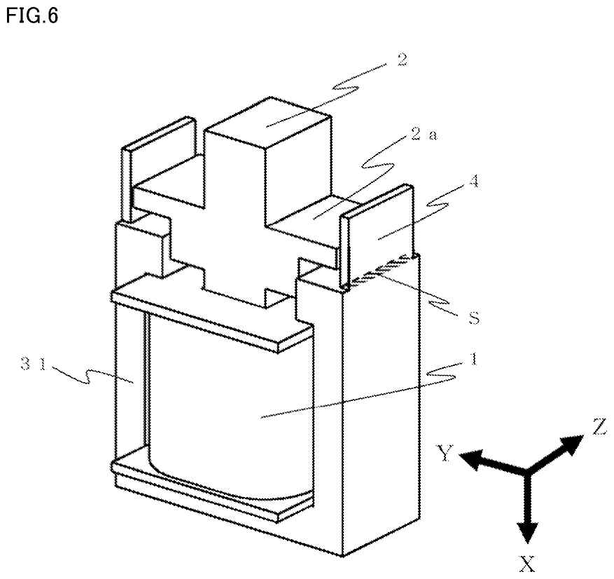

Embodiment 1 shows the solenoid provided with the movable core 2 which has: the convex portion 2b at one end; and, on the other end side, the stair-shaped protrusion portion 2a which is provided in the right-and-left symmetrical manner in the direction perpendicular to the rectilinear motion direction and whose end portion on the solenoid coil 1 side is tiered. In Embodiment 2, a fixed core 31 that does not have the projection portion 3c of the fixed core 3 is constituted and a yoke 4 is newly provided on an end portion of an upper surface of the fixed core 31. Specific description will be described later using FIG. 6. Configuration other than that is the same as Embodiment 1, the same reference numerals are given to the same configuration as Embodiment 1, and the description thereof will be omitted.

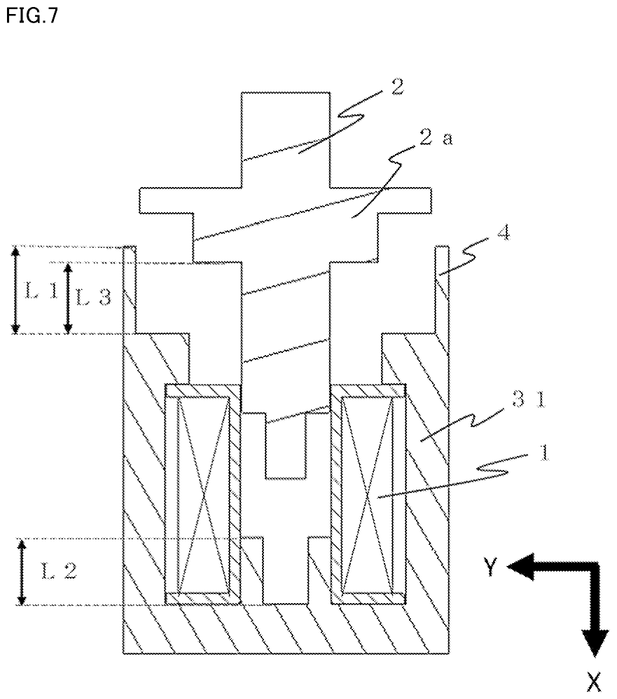

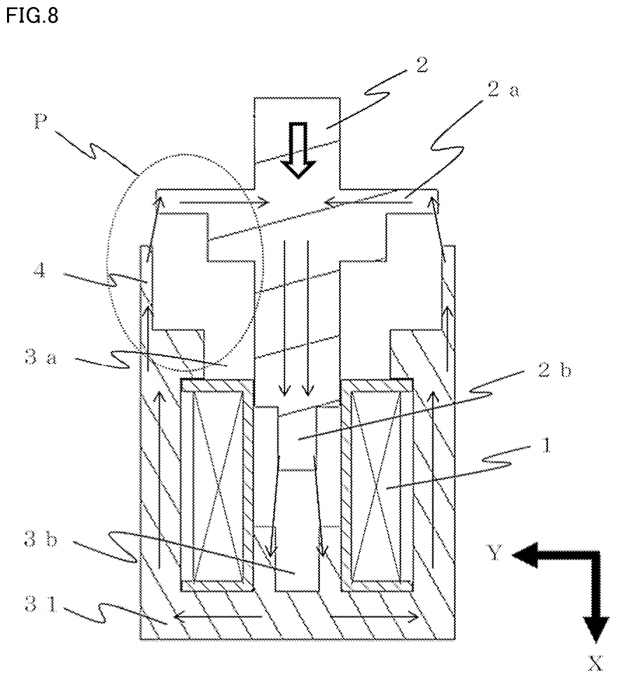

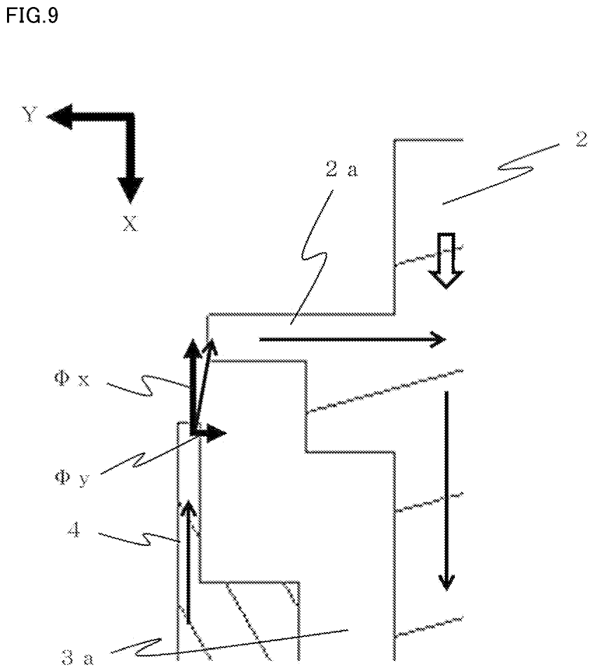

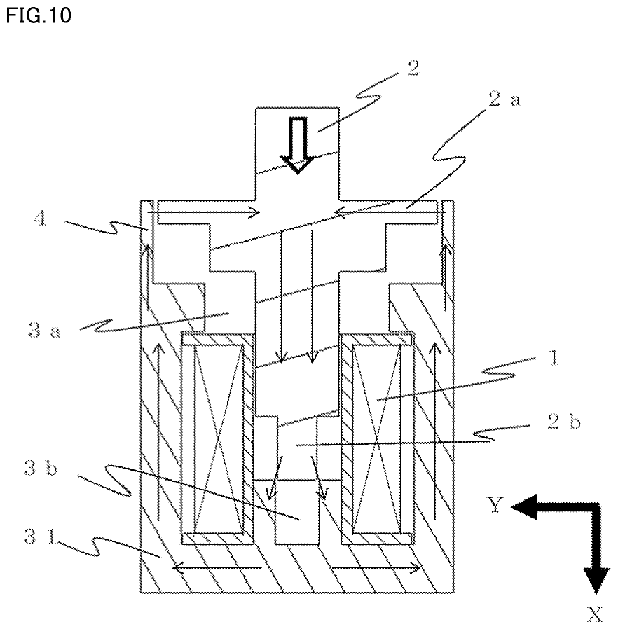

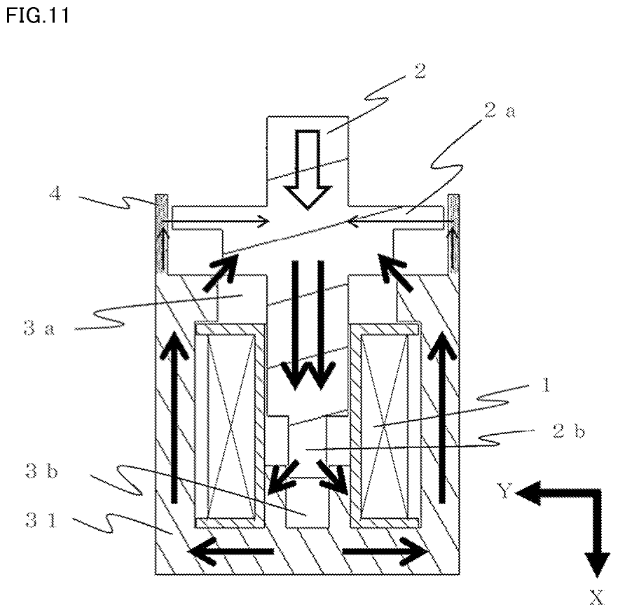

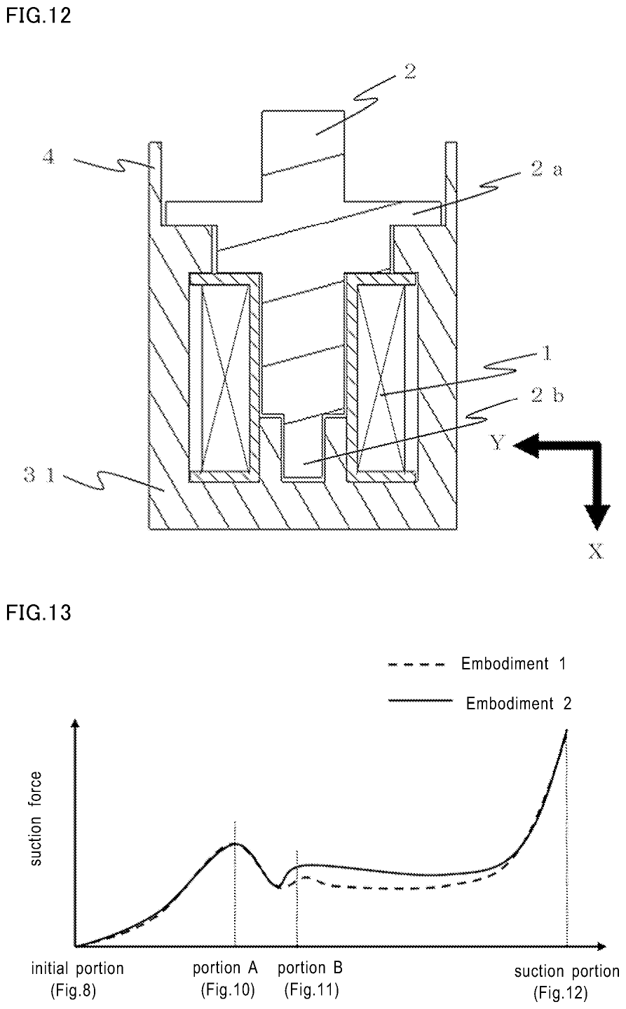

The present embodiment will be described using FIG. 6 through FIG. 14. FIG. 6 is a perspective view of a solenoid according to the present embodiment. FIG. 7 is a view defining the relationship of lengths according to the present embodiment. FIG. 8 is a view showing the solenoid at an initial position according to the present embodiment. FIG. 9 is an enlarged view corresponding to a P portion of FIG. 8 and showing the relationship between a magnetic flux that flows in a space gap and suction force according to the present embodiment. FIG. 10 is a view showing the solenoid at a midway position according to the present embodiment. FIG. 11 is a view showing the solenoid at a midway position according to the present embodiment. FIG. 12 is a view showing the solenoid at a suction position according to the present embodiment. FIG. 13 is a chart in which suction forces of solenoids according to a comparison embodiment and the present embodiment are compared.

As shown in FIG. 6, in the solenoid according to the present embodiment, the fixed core 31 that does not have the projection portion 3c of the fixed core 3 is constituted and the yoke 4 is newly provided on the end portion of the upper surface of the fixed core 31. The yoke 4 is provided extending in an opposite direction to the solenoid coil 1 on the end portion of the upper surface of the fixed core 31. Furthermore, a sectional area S of the yoke 4 is set so that the yoke 4 is to be magnetically saturated when the height of a lowermost surface of a protrusion portion 2a conforms to that of the upper surface of the fixed core 31. In order to make the yoke 4 to be magnetically saturated at the desired timing, the sectional area S of the yoke 4 shown in FIG. 6 may be set by adjusting the thickness and the width of the yoke 4.

FIG. 7 is a view that defines the relationship of lengths. In FIG. 7, the height of the yoke 4 is defined as L1; the depth of a first concave portion 3b provided on a bottom portion of the fixed core 31, L2; and the height between the lowermost surface of the protrusion portion 2a and the height of the upper surface of the fixed core 31, L3. In the present embodiment, the height of the yoke 4 is set to be higher than the depth of the first concave portion 3b provided on the bottom portion of the fixed core 31. More specifically, in the present embodiment, the height of the yoke 4 is set to be L1≥L2, and the sectional area S of the yoke 4 is determined so that the yoke 4 is to be magnetically saturated when L3=0.

Next, operation will be described using FIG. 8 through FIG. 12. FIG. 8 is the view showing the solenoid at the initial position. The initial position in the present embodiment is a state where the lowermost surface of the protrusion portion 2a is higher than the upper surface of the fixed core 31. At the initial position shown in FIG. 8, when a current flows through the solenoid coil 1, a magnetic path is formed by the yoke 4, the protrusion portion 2a, the movable core 2, the convex portion 2b, and the fixed core 31. The magnetic flux flows in the space gap between the movable core 2 and the fixed core 31, thereby generating suction force Fx that rectilinearly moves the movable core 2 in an X-axis direction. Description will be made specifically using FIG. 9.

FIG. 9 is the enlarged view corresponding to the P portion of

FIG. 8. As shown in FIG. 9, of the magnetic fluxes that flow the space gap between the yoke 4 and the protrusion portion 2a, the suction force Fx is generated by a magnetic flux Φx that flows in the X-axis direction, and the movable core 2 is sucked to the X-axis direction. Furthermore, the space gap between the movable core 2 and the fixed core 31 is reduced by the rectilinear motion of the movable core 2, whereby magnetic resistance is lowered and thus the magnetic flux obtained from the solenoid coil 1 is increased.

FIG. 10 is the view showing the solenoid at a position A. The position A indicates the time when the height of an upper surface of the protrusion portion 2a conforms to that of an upper surface of the yoke 4 in the solenoid according to the present embodiment. As shown in FIG. 10 at the position A, in the magnetic flux that flows in the space gap, the proportion that flows in a Y-axis direction is increased and the proportion that flows in the x-axis direction is decreased. Therefore, the magnetic flux that flows in the X-axis direction is decreased, thereby lowering the suction force Fx.

FIG. 11 is the view showing the solenoid at a position B. The position B indicates the time when the height of the lowermost surface of the protrusion portion 2a conforms to that of the upper surface of the fixed core 31 in the solenoid according to the present embodiment. The magnetically saturated yoke 4 is shown applying hatching different from the movable core 2 and the fixed core 31. As shown in FIG. 11, the sectional area S of the yoke 4 is set so that the yoke 4 is to be magnetically saturated when the height of the lowermost surface of the protrusion portion 2a conforms to that of the upper surface of the fixed core 31, that is, when L3=0. This suppresses the magnetic flux that flows from the fixed corte 31 to the yoke 4 from becoming more than a constant amount and increases the magnetic flux that flows between the fixed core 31 whose magnetic resistance is small and the protrusion portion 2a. More specifically, the proportion that flows in the x-axis direction in the space gap is increased, whereby the magnetic flux obtained from the solenoid coil 1 can be converted into the suction force Fx that rectilinearly moves the movable core 2 more efficiently.

FIG. 12 is the view showing the solenoid at the suction position. The movable core 2 is rectilinearly moved by the suction force Fx; and the convex portion 2b and the protrusion portion 2a are respectively fitted in and brought into contact with the first concave portion 3b and the second concave portion 3a, whereby the movable core 2 is stopped.

In the present embodiment, the sectional area S of the yoke 4 is designed and the height is set so that the yoke 4 is to be magnetically saturated when the height of the lowermost surface of the protrusion portion 2a conforms to that of the upper surface of the fixed core 31, that is, when L3=0. Here, a comparison of the suction force Fx is made between the present embodiment and the comparison embodiment using FIG. 13. The comparison embodiment is the solenoid according to the present embodiment in which the yoke 4 is not magnetically saturated at the position B. FIG. 13 is the chart in which the suction forces Fx of the solenoids according to the present embodiment and the solenoid according to the comparison embodiment are compared.

As shown in FIG. 13, it shows that the yoke 4 is magnetically saturated at the position B in the solenoid according to the present embodiment, whereby the magnetic flux that flows from the fixed core 31 to the protrusion portion 2a is increased and the suction force Fx is improved compared to the solenoid according to the comparison embodiment. From this result, it can be said that the magnetic flux obtained from the solenoid coil 1 can be converted into the suction force Fx that efficiently contributes to rectilinear motion movement of the movable core 2 in the solenoid according to the present embodiment.

From the above, the solenoid according to the present embodiment is formed so that the yoke 4 is to be magnetically saturated when the height of the lowermost surface of the protrusion portion 2a conforms to that of the upper surface of the fixed core 31, that is, when L3=0, whereby the magnetic flux of the Y-axis direction which flows from the yoke 4 to the protrusion portion 2a and does not contribute to the suction force Fx can be suppressed. Furthermore, the sectional area S of the yoke 4 is set so that the yoke 4 is to be magnetically saturated when the height of the lowermost surface of the protrusion portion 2a conforms to that of the upper surface of the fixed core 31, that is, when L3=0, whereby the magnetic flux that flows from the fixed core 31 to the protrusion portion 2a can be increased. As described above, the magnetic flux that contributes to the suction force Fx is increased and the magnetic flux that does not contribute to the suction force Fx is suppressed, thereby obtaining the solenoid that can rectilinearly move the movable core 2 efficiently.

Furthermore, the present embodiment shows the solenoid in which the yoke 4 is magnetically saturated when the height of the lowermost surface of the protrusion portion 2a conforms to that of the upper surface of the fixed core 31, that is, when L3=0; however, the timing to be magnetically saturated is not limited to the time when the height of the lowermost surface of the protrusion portion 2a conforms to that of the upper surface of the fixed core 31, that is, when L3=0. For example, the above effect can be obtained also when the yoke 4 is to be magnetically saturated before and after the timing (L3=0) when the height of the lowermost surface of the protrusion portion 2a conforms to that of the upper surface of the fixed core 31.

Furthermore, the present embodiment illustrates and describes the fixed core 31 that does not have the projection portion 3c; however, a similar effect is obtained also when the fixed core 3 that has the projection portion 3c illustrated in Embodiment 1 is used.

### Embodiment 3

In the present embodiment, the height of a yoke 4 is set to be lower than the depth of a first concave portion 3b (L1<L2). Furthermore, a sectional area S of the yoke 4 is determined so that the yoke 4 is to be magnetically saturated when the height of an upper surface of a protrusion portion 2a conforms to that of an upper surface of the yoke 4 and the yoke 4 is provided on an end portion of an upper surface of a fixed core 31. Configuration other than that is the same as Embodiment 2, the same reference numerals are given to the same configuration as Embodiment 2, and the description thereof will be omitted.

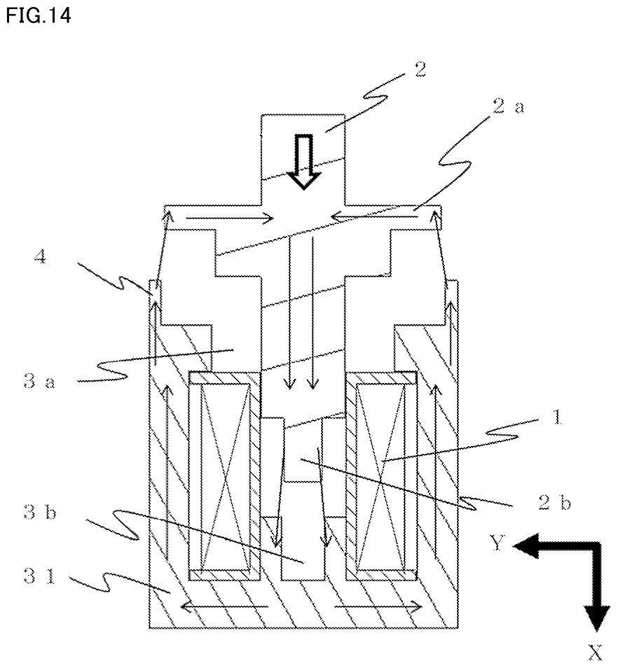

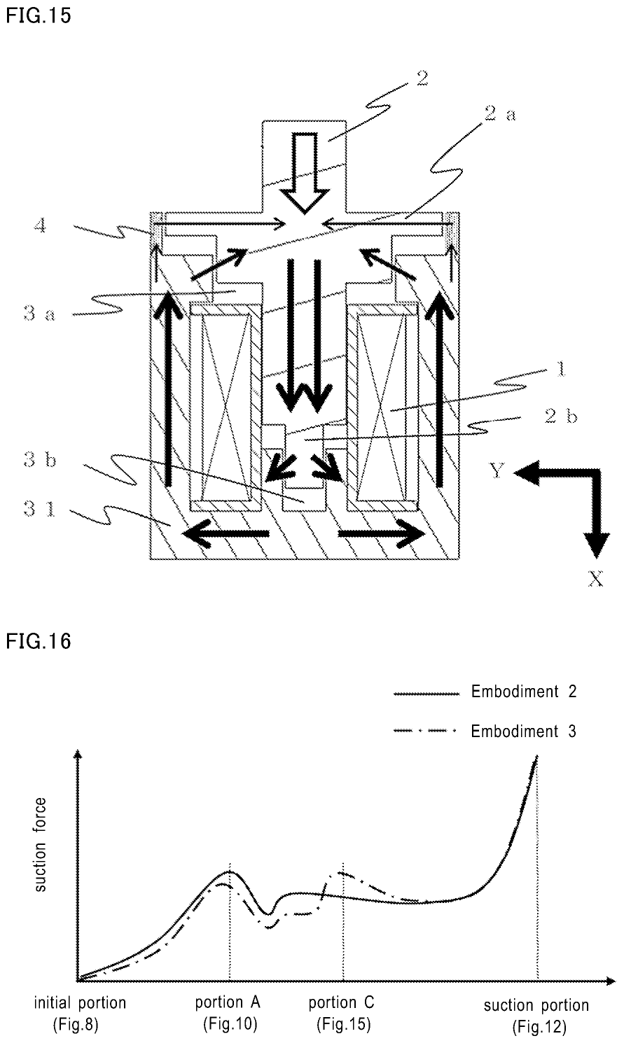

The present embodiment will be described using FIG. 14 through FIG. 16. FIG. 14 is a view showing a solenoid at an initial position according to the present embodiment. FIG. 15 is a view showing the solenoid at a midway position according to the present embodiment. FIG. 16 is a chart in which suction forces of the solenoids according to Embodiment 2 and Embodiment 3 of the present disclosure are compared.

As shown in FIG. 14, the solenoid according to the present embodiment is provided with the yoke 4 so that the height of the yoke 4 is lower than the depth of the first concave portion 3b. The initial position is a state where the protrusion portion 2a of the movable core 2 is higher than the upper surface of the yoke 4. When a current flows through solenoid coil 1 at the initial position, a magnetic path is formed by the yoke 4, the protrusion portion 2a, a movable core 2, a convex portion 2b, and the fixed core 31. Then, suction force Fx is generated by a magnetic flux that flows in a space gap between the movable core 2 and the fixed core 31 and the movable core 2 is rectilinearly moved to an X-axis direction.

FIG. 15 illustrates the solenoid at the timing when the yoke 4 is magnetically saturated. A position C is a state of the solenoid according to the present embodiment at the time when the height of the upper surface of the protrusion portion 2a conforms to that of the upper surface of the yoke 4, shown in FIG. 15. Incidentally, FIG. 15 shows the magnetically saturated yoke 4 in which hatching different from the movable core 2 and the fixed core 31 is applied. The yoke 4 is made to be magnetically saturated when the height of the upper surface of the protrusion portion 2a conforms to that of the yoke 4, whereby the magnetic flux that flows from the fixed corte 31 to the yoke 4 is suppressed from becoming more than a constant amount. Furthermore, the magnetic flux that flows from the fixed core 31 having small magnetic resistance to the protrusion portion 2a is increased. More specifically, the magnetic flux that does not contribute to the suction force Fx is suppressed and the magnetic flux that contributes to the suction force Fx is increased, whereby the magnetic flux obtained from the solenoid coil 1 can be converted into the suction force Fx that rectilinearly moves the movable core 2 efficiently.

Here, a comparison is made on the suction forces Fx between Embodiment 2 and the present embodiment using FIG. 16. FIG. 16 is the chart in which the suction forces of the solenoids according to Embodiment 2 and the solenoid according to the present embodiment are compared.

The magnitude relationship between the height of the yoke 4 and the depth of the first concave portion 3b is different in Embodiment 2 and the present embodiment. It can be found that, from FIG. 16, the solenoid according to the present embodiment improves the suction force Fx at the position C compared to the solenoid according to Embodiment 2. More specifically, it can be said that the space gap between the movable core 2 and the fixed core 31 is reduced and the suction force Fx can be improved also when the distance between the movable core 2 and the fixed core 31 is near.

As described above, in the solenoid according to the present embodiment, the sectional area S of the yoke 4 is set so that the height of the yoke 4 is lower than the depth of the first concave portion 3b. This can improve the suction force Fx at the position that is near in distance between the movable core 2 and the fixed core 31 and the suction force Fx can be improved at the desired timing also in the case of being set to output characteristics required for the solenoid.

Furthermore, the present embodiment shows the solenoid in which the yoke 4 is magnetically saturated when the height of the upper surface of the protrusion portion 2a conforms to that of the upper surface of the yoke 4; however, for example, the above effect can be obtained also when the yoke 4 is to be magnetically saturated before and after the timing when the height of the upper surface of the protrusion portion 2a conforms to that of the upper surface of the yoke 4.

Besides, the present embodiment illustrates and describes the fixed core 31 that does not have a projection portion 3c; however, a similar effect is obtained also when the fixed core 3 that has the projection portion 3c illustrated in Embodiment 1 is used.

Although the description has been made on one example of the solenoid that makes the yoke 4 to be magnetically saturated in Embodiments 2 and 3, a point of time when the yoke 4 is made to be magnetically saturated is not limited to the point of time of Embodiment 2, 3, but it may be permissible that that the yoke 4 is set to be magnetically saturated during the movement of the movable core 2, more specifically, while the movable core 2 is rectilinearly moved from the initial position to the suction position. As described above, it is set so that the yoke 4 is to be magnetically saturated in the midway of the movement of the movable core 2, whereby the magnetic flux that flows through the yoke 4 via the protrusion portion 2a can be suppressed and adjustment of the suction force Fx can be performed.

Furthermore, it is set so that the yoke 4 is to be magnetically saturated after the time when a component of a Y-axis direction of a magnetic flux (oblique magnetic flux) generated between the fixed core 3 and the protrusion portion 2a is larger than a component of the X-axis direction of a magnetic flux generated between the yoke 4 and a tip end part of the protrusion portion 2a, whereby the magnetic flux of the X-axis direction can be increased and the improvement of the suction force Fx can be obtained.

### Embodiment 4

The solenoid provided with the yoke 4 on the end portion of the upper surface of the fixed core 31 has been shown in the previous embodiments; however, in the present embodiment, a solenoid provided with a yoke 41 on an end portion of a protrusion portion 2a is shown. More specifically, a sectional area S of the yoke 41 is set so that the yoke 41 extended to a solenoid coil 1 side provided on the end portion of the protrusion portion 2a is to be magnetically saturated when the height of an upper surface of a fixed core 31 conforms to that of a lowermost surface of the protrusion portion 2a. Configuration other than that is the same as Embodiment 3, the same reference numerals are given to the same configuration as Embodiment 3, and the description thereof will be omitted.

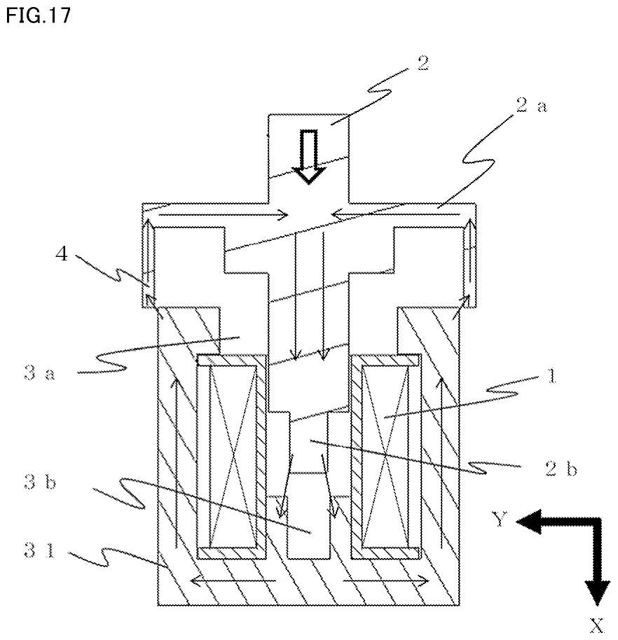

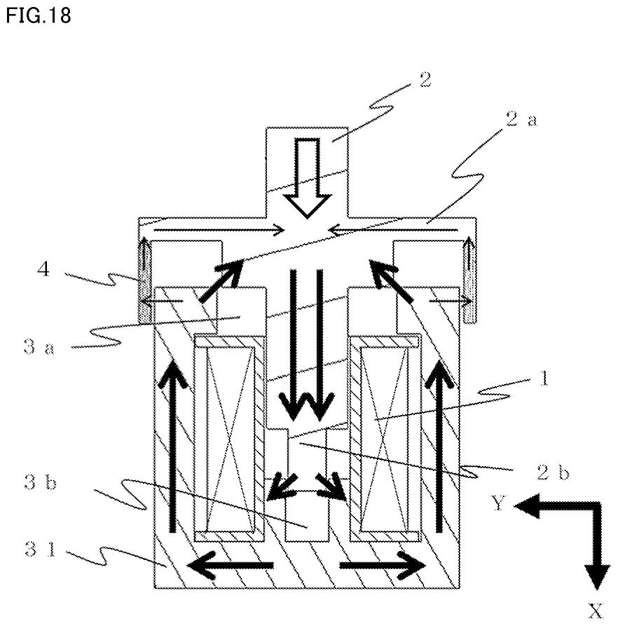

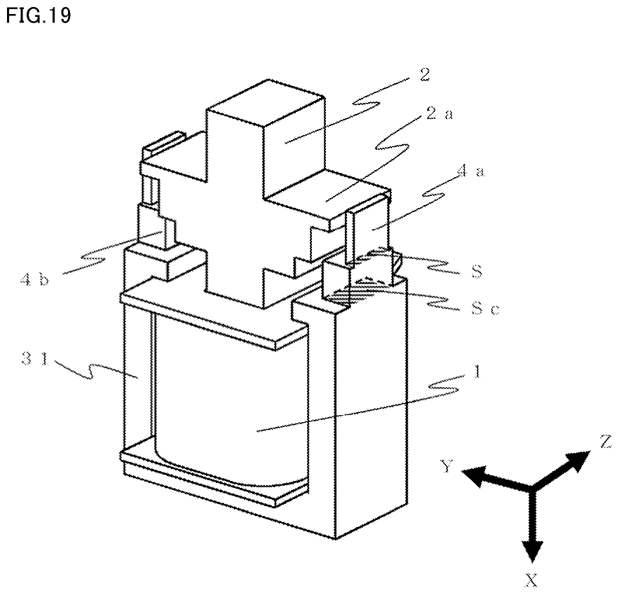

The present embodiment will be described using FIG. 17 and FIG. 18. FIG. 17 is a view showing the solenoid at an initial position according to the present embodiment. FIG. 18 is a view showing the solenoid in which the yoke according to the present embodiment is magnetically saturated.

As shown in FIG. 17, the solenoid according to the present embodiment sets the sectional area S of the yoke 41 so that the yoke 41 extended to the solenoid coil 1 side is to be magnetically saturated when the height of the lowermost surface of the protrusion portion 2a conforms to that of the upper surface of the fixed core 31. A state in a position where the lowermost surface of the protrusion portion 2a is higher than the upper surface of the fixed core 31 is referred to as the initial position. When a current flows through the solenoid coil 1 at the initial position, a magnetic path is formed by the yoke 41, the protrusion portion 2a, a movable core 2, a convex portion 2b, and the fixed core 31. Then, suction force Fx is generated by a magnetic flux that flows in a space gap between the movable core 2 and the fixed core 31; and the movable core 2 is rectilinearly moved in an X-axis direction.

FIG. 18 illustrates the solenoid at the timing when the yoke 41 is magnetically saturated, that is, at the timing when the height of the upper surface of the fixed core 31 conforms to that of the lowermost surface of the protrusion portion 2a. Incidentally, FIG. 18 shows the magnetically saturated yoke 41 in which hatching different from the movable core 2 and the fixed core 31 is applied. The yoke 41 is made to be magnetically saturated when the height of the lowermost surface of the protrusion portion 2a conforms to that of the upper surface of the fixed core 31, whereby the magnetic flux that flows from the fixed corte 31 to the yoke 4 is suppressed from becoming more than a constant amount. Furthermore, the magnetic flux that flows from the fixed core 31 having small magnetic resistance to the protrusion portion 2a is increased. More specifically, the magnetic flux that does not contribute to the suction force Fx is suppressed and the magnetic flux that contributes to the suction force Fx is increased, whereby the magnetic flux obtained from the solenoid coil 1 can be converted into the suction force Fx that rectilinearly moves the movable core 2 efficiently.

As described above, the present embodiment shows the solenoid in which the sectional area S of the yoke 41 is set so that the yoke 41 extended to the solenoid coil 1 side of the protrusion portion 2a is to be magnetically saturated when the height of the upper surface of the fixed core 31 conforms to that of the lowermost surface of the protrusion portion 2a. This improves the suction force Fx and can rectilinearly move the movable core 2 efficiently also when the position where the yoke 41 is to be attached is changed.

Furthermore, the present embodiment shows the solenoid in which the yoke 41 is magnetically saturated when the height of the lowermost surface of the protrusion portion 2a conforms to that of the upper surface of the fixed core 31; however, for example, the above effect can be obtained also when the yoke 41 is to be magnetically saturated before and after the timing when the height of the lowermost surface of the protrusion portion 2a conforms to that of the upper surface of the fixed core 31.

Besides, in the present embodiment, the fixed core 31 that does not have a projection portion 3c is illustrated and described; however, a similar effect is obtained also when the fixed core 3 that has the projection portion 3c illustrated in Embodiment 1 is used.

### Embodiment 5

The embodiments so far have shown the solenoid provided with the stair-shaped protrusion portion 2a whose end portion on the solenoid coil 1 side is tiered. In the present embodiment, a solenoid provided with a protrusion portion 2a that has a plurality of steps will be shown. Furthermore, a plurality of yokes of different sectional areas in which the sectional areas are set so that the yokes are to be magnetically saturated according to the number of steps of the protrusion portion 2a are provided. Configuration other than that is the same as Embodiment 2; and the same reference numerals are given to the same configuration as Embodiment 2 and the description thereof will be omitted.

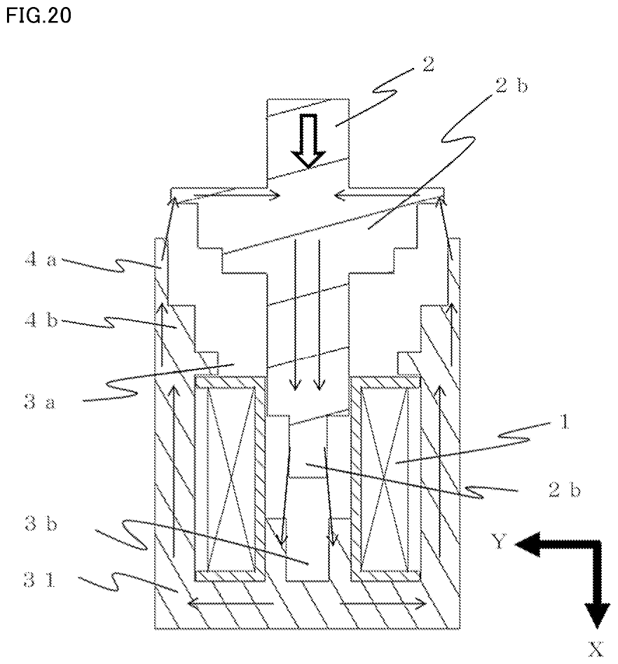

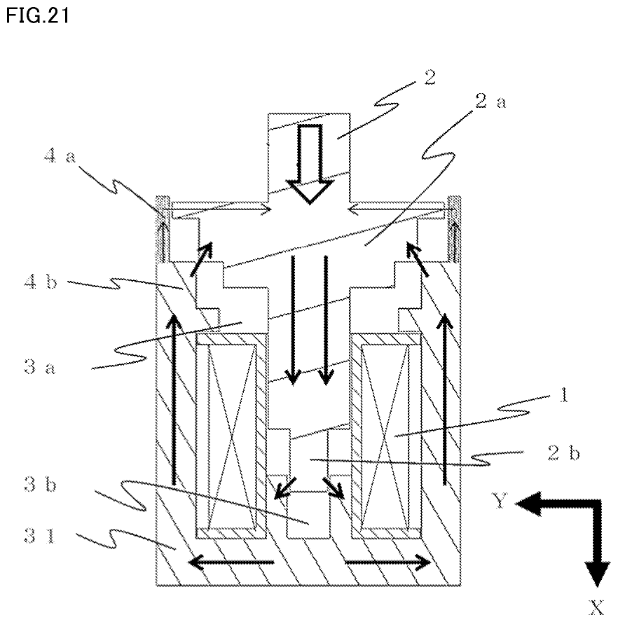

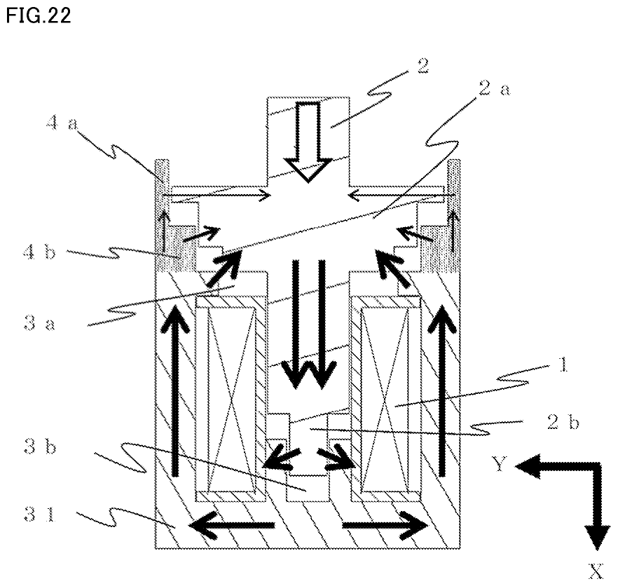

The present embodiment will be described using FIG. 19 through FIG. 22. FIG. 19 is a perspective view of the solenoid according to the present embodiment. FIG. 20 is a view showing the solenoid at an initial position according to the present embodiment. FIG. 21 is a view showing the solenoid in which a yoke 4a according to the present embodiment is magnetically saturated. FIG. 22 is a view showing the solenoid in which a yoke 4b according to the present embodiment is magnetically saturated.

As shown in FIG. 19, the protrusion portion 2a of a movable core 2 is formed in a stair shape that has a plurality of steps in an end portion. The sectional areas of the yokes extended upward, which are provided on an end portion of an upper surface of a fixed core 31, are set so that the yokes are to be magnetically saturated in a stepwise manner in accordance with the protrusion portion 2a. In FIG. 19, the sectional area of the yoke 4a and that of the yoke 4b are respectively set to S and Sc (Sc>S), and the yoke 4b and the yoke 4a are provided in order from the upper surface of the fixed core 31. Furthermore, in FIG. 19, the protrusion portion 2a having two steps (four steps of right and left in total) is illustrated as an example; however, it may be permissible that the steps are three or more in number and a plurality of yokes of different sectional area is provided correspondingly.

Next, operation will be described. FIG. 20 is the view showing the solenoid at the initial position. The initial position is a state where a lowermost surface of the protrusion portion 2a is located at a position higher than the upper surface of the fixed core 31. When a current flows through the solenoid coil 1 at the initial position, a magnetic path is formed by the yoke 4b, the yoke 4a, the protrusion portion 2a, the movable core 2, a convex portion, and the fixed core 31. Then, suction force Fx is generated by a magnetic flux that flows in a space gap between the movable core 2 and the fixed core 31 and the movable core 2 is rectilinearly moved in an X-axis direction.

Then, as shown in FIG. 21, when the height of an upper surface of the yoke 4b conforms to that of a lower surface of the protrusion portion 2a that is second nearest to the fixed core 31, the yoke 4a is magnetically saturated. Incidentally, FIG. 21 shows the magnetically saturated yoke 4a in which hatching different from the movable core 2, the fixed core 31, and the yoke 4b is applied. The yoke 4a is made to be magnetically saturated, whereby the magnetic flux that flows from the yoke 4b to the yoke 4a is suppressed from becoming more than a constant amount. Furthermore, the magnetic flux that flows from the yoke 4b having small magnetic resistance to the protrusion portion 2a is increased. More specifically, the magnetic flux that does not contribute to the suction force Fx is suppressed and the magnetic flux that contributes to the suction force Fx is increased, whereby the magnetic flux obtained from the solenoid coil 1 can be converted into the suction force Fx that rectilinearly moves the movable core 2 efficiently.

Further, as shown in FIG. 22, the yoke 4b is magnetically saturated when the height of the upper surface of the fixed core 31 conforms to that of the lowermost surface of the protrusion portion 2a. Incidentally, FIG. 22 shows the magnetically saturated yoke 4a and the yoke 4b in which hatching different from the movable core 2 and the fixed core 31 is applied. The yoke 4b is made to be magnetically saturated, whereby the magnetic flux that flows from the fixed core 31 to the yoke 4b is suppressed from becoming more than a constant amount. Furthermore, the magnetic flux that flows from the fixed core 31 having small magnetic resistance to the protrusion portion 2a is increased. This increases the proportion of the magnetic flux that flows in the x-axis direction, and the magnetic flux obtained from the solenoid coil 1 can be converted into the suction force Fx that rectilinearly moves the movable core 2 efficiently.

From the above, the present embodiment shows the solenoid which has a plurality of steps and has the stair-shaped protrusion portion 2a whose end portion on the solenoid coil 1 side is tiered. Furthermore, the sectional area S of the yoke 4a and the sectional area Sc of the yoke 4b are set so that a plurality of stages of the timing at which the yoke 4a and the yoke 4b are magnetically saturated is provided according to the number of steps of the protrusion portion 2a. This can improve the suction force Fx in the plurality of stages and obtains the solenoid that rectilinearly moves the movable core 2 efficiently.

Furthermore, the present embodiment exemplifies the solenoid in which the yoke 4a and the yoke 4b are magnetically saturated when the height of the upper surface of the yoke 4b conforms to that of the lower surface of the protrusion portion 2a that is second nearest to the fixed core 31 and when the height of the upper surface of the fixed core 31 conforms to that of the lowermost surface of the protrusion portion 2a. However, the timing to be magnetically saturated is not limited to this; for example, the above effect can be obtained also when the yoke 4a is to be magnetically saturated before and after the timing when the height of the upper surface of the yoke 4b conforms to that of the lower surface of the protrusion portion 2a that is second nearest to the fixed core 31. Similarly, the above effect can be obtained also when the yoke 4b is to be magnetically saturated before and after the timing when the height of the upper surface of the fixed core 31 conforms to that of the lowermost surface of the protrusion portion 2a.

Besides, in the present embodiment, the fixed core 31 that does not have a projection portion 3c is illustrated and described; however, a similar effect is obtained also when the fixed core 3 that has the projection portion 3c illustrated in Embodiment 1 is used. In addition, it may be permissible that the yoke 4a and the yoke 4b are provided on the protrusion portion 2a as with the solenoid according to Embodiment 4.

### Embodiment 6

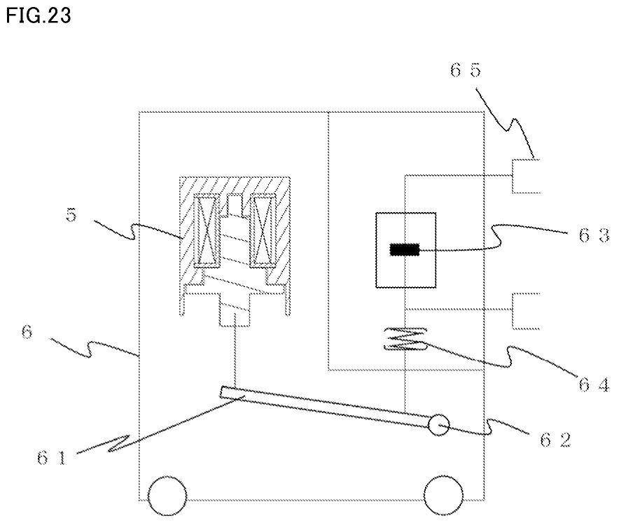

The present embodiment shows an example in which a solenoid 5 according to the embodiments so far is applied to a switch. FIG. 23 is a view showing the example in which the solenoid is applied to the switch.

As shown in FIG. 23, a switch 6 has: contact points 63 which perform connection and separation by a fixed contact point in which a fixed contact has and a movable contact in which a movable contact has; and the solenoid 5 which is connected to the movable contact to actuate the movable contact.

Operation will be described. A current flows through the solenoid 5 and a movable core 2 is made to move rectilinearly, thereby actuating a lever 61. Rectilinear motion movement of the movable core 2 is utilized to close the contact points 63, thereby shifting to an energized state. This enables the switch 6 to be actuated by an electrical signal. The solenoids 5 according to Embodiment 1 through 5 are applied to the switch according to the present embodiment, whereby suction force Fx necessary for closing operation of the switch can be obtained from a small current.

As described above, the present embodiment shows the switch to which the solenoids 5 according to the present Embodiment 1 through 5 are applied. As just described, the closing operation of the switch can be performed by the small current. The present embodiment shows the example applied to the switch as one case, but not limited to this.

### DESCRIPTION OF REFERENCE NUMERALS

1 Solenoid coil, 2 Movable core, 2a Protrusion portion, 2b Convex portion, 3, 31 Fixed core, 3a Second concave portion, 3b First concave portion, 3c Projection portion, 4, 41, 4a, 4b Yoke, 5 Solenoid, 6 Switch, 61 Lever, 62 Fulcrum, 63 Contact point, 64 Contact pressure spring, 65 Main circuit portion, Fx Suction force

1-7. (canceled)

8. A solenoid comprising:
a solenoid coil which produces a magnetic flux due to excitation by energization and generates electromagnetic force by which suction force is exerted axially in a hollow portion;
a movable core whose one end is rectilinearly moved in the hollow portion by the electromagnetic force, and which has, on the other end side, a protrusion portion which is provided in a right-and-left symmetrical manner in a direction perpendicular to a rectilinear motion direction and whose end portion on the solenoid coil side is tiered; and
a fixed core which surrounds the solenoid coil and is provided with a concave portion in which the protrusion portion is to be fitted.

9. The solenoid according to claim 8,
wherein the fixed core has a yoke that is extended in an opposite direction to the solenoid coil on an upper surface of the fixed core.

10. The solenoid according to claim 8,
wherein the protrusion portion has a yoke that is extended in the rectilinear motion direction on the end portion.

11. The solenoid according to claim 9,
wherein the yoke is provided so as to be magnetically saturated when the movable core is rectilinearly moved.

12. The solenoid according to claim 10,
wherein the yoke is provided so as to be magnetically saturated when the movable core is rectilinearly moved.

13. The solenoid according to claim 9,
wherein the yoke is provided so as to be magnetically saturated when the height of a lowermost surface of the protrusion portion conforms to that of the upper surface of the fixed core.

14. The solenoid according to claim 10,
wherein the yoke is provided so as to be magnetically saturated when the height of a lowermost surface of the protrusion portion conforms to that of the upper surface of the fixed core.

15. The solenoid according to claim 11,
wherein the yoke is provided so as to be magnetically saturated when the height of a lowermost surface of the protrusion portion conforms to that of the upper surface of the fixed core.

16. The solenoid according to claim 12,
wherein the yoke is provided so as to be magnetically saturated when the height of a lowermost surface of the protrusion portion conforms to that of the upper surface of the fixed core.

17. The solenoid according to claim 9,
wherein the yoke is provided so as to be magnetically saturated when the movable core is rectilinearly moved and the height of an upper surface of the yoke conforms to that of an upper surface of the protrusion portion.

18. A switch comprising:
a fixed contact which has a fixed contact point;
a movable contact which has a movable contact point that is connected to and separated from the fixed contact point; and
a solenoid as set forth in claim 8 which is connected to the movable contact to actuate the movable contact.

19. A switch comprising:
a fixed contact which has a fixed contact point;
a movable contact which has a movable contact point that is connected to and separated from the fixed contact point; and
a solenoid as set forth in claim 9 which is connected to the movable contact to actuate the movable contact.

20. A switch comprising:
a fixed contact which has a fixed contact point;
a movable contact which has a movable contact point that is connected to and separated from the fixed contact point; and
a solenoid as set forth in claim 10 which is connected to the movable contact to actuate the movable contact.

21. A switch comprising:
a fixed contact which has a fixed contact point;
a movable contact which has a movable contact point that is connected to and separated from the fixed contact point; and
a solenoid as set forth in claim 11 which is connected to the movable contact to actuate the movable contact.

22. A switch comprising:
a fixed contact which has a fixed contact point;
a movable contact which has a movable contact point that is connected to and separated from the fixed contact point; and
a solenoid as set forth in claim 12 which is connected to the movable contact to actuate the movable contact.

23. A switch comprising:
a fixed contact which has a fixed contact point;
a movable contact which has a movable contact point that is connected to and separated from the fixed contact point; and
a solenoid as set forth in claim 13 which is connected to the movable contact to actuate the movable contact.

24. A switch comprising:
a fixed contact which has a fixed contact point;
a movable contact which has a movable contact point that is connected to and separated from the fixed contact point; and
a solenoid as set forth in claim 14 which is connected to the movable contact to actuate the movable contact.

25. A switch comprising:
a fixed contact which has a fixed contact point;
a movable contact which has a movable contact point that is connected to and separated from the fixed contact point; and
a solenoid as set forth in claim 15 which is connected to the movable contact to actuate the movable contact.

26. A switch comprising:
a fixed contact which has a fixed contact point;
a movable contact which has a movable contact point that is connected to and separated from the fixed contact point; and
a solenoid as set forth in claim 16 which is connected to the movable contact to actuate the movable contact.

27. A switch comprising:
a fixed contact which has a fixed contact point;
a movable contact which has a movable contact point that is connected to and separated from the fixed contact point; and
a solenoid as set forth in claim 17 which is connected to the movable contact to actuate the movable contact.
